(19) United States
(12) Patent Application Publication
(10) Pub. No.: US 2008/0125169 A1
(43) Pub. Date: May 29, 2008

(54) Communication Apparatus and Method

(76) Inventor: Attila Paul Kozak, Langley (CA)

Correspondence Address: GLENN PATENT GROUP, 3475 EDISON WAY, SUITE L, MENLO PARK, CA, 94025, US

(21) Appl. No.: 11/871,662

(22) Filed: Oct. 12, 2007

(30) Foreign Application Priority Data
Nov. 28, 2006 (CA) 2,569,184

(51) Int. Cl. H04M 1/00

(52) U.S. Cl. 455/556.1

(57) ABSTRACT

A communication apparatus includes a distinct set of keys dedicated to producing musical notes, by which musical patterns can be created, stored and shared between users. The musical patterns may be used as identifiable audio signals to contact other users, and to signal incoming communications from other users. A method of communicating using such an apparatus, including the steps of creating a musical pattern, associating it with an address, and contacting the address upon inputting the pattern, or playing the pattern upon receipt of a signal from the associated address. Patterns may be shared between users, and users may modify or add to each other's patterns.

### BACKGROUND OF THE INVENTION

In communication devices, in order to specify a recipient or addressee of the communication, an alphanumeric sequence representing the intended recipient of the communication (for example a telephone number) is keyed in using a set of keys in which each key typically represents one character of the character set. For the typical Roman alphabet alphanumeric character set, this requires a keypad or keyboard having a relatively large number of keys in which each key represents a unique alphanumeric character. This is the case for telephone handsets, communication-enabled PDAs and computer keyboards (when used for email).

Fewer than the full complement of keys may be used by providing auxiliary function keys (for example the “shift” key on a keyboard) that modify the character assignment for given keys. The user still inputs the full alphanumeric code for the intended recipient but does so using variable key assignments. In such case, the user is still required to remember and use a sequence of alphanumeric characters that is usually not intuitive. The user generally also requires visual access to the keypad or keyboard in order to dial without error. This represents a limitation in the manner of use for many communication devices.

Ring tones have become popular accessories for telephones and mobile devices. A plurality of downloaded ring tones can be used and selected for playback according to the type of incoming communication (SMS, email, telephone call). A particular ringtone may also be used to indicate that an incoming call is from a particular user. To date, such ring tones have been provided as downloadable files and no functionality is provided on the telephone handset for enabling the composition of music useable as a ring tone, or indeed for any other use.

It is an object of the present invention to provide a keypad input device for a communication device that enables a user to generate musical patterns using dedicated music keys.

It is a further object of the invention to be able to identify an intended recipient or addressee (as opposed to an incoming caller) by a memorable musical pattern, for example a particular riff.

It is a further object of the invention to provide such a device wherein the input may be keyed in using a very small number of conveniently located keys that provide auditory feedback, thereby obviating the need to see the keys or keypad when dialing.

Other objects of the invention will be appreciated by reference to the disclosure and claims that follow.

### SUMMARY OF THE INVENTION

The preferred embodiment of the invention comprises communication apparatus equipped with between one and five dedicated music keys. Each dedicated key may be associated with a musical note or notes which is/are sounded when the key is pressed. The dedicated keys are preferably located on or towards a side of the communication apparatus, for ready access by a user.

In one aspect of the invention, individual musical patterns that are generated by pressing a succession of dedicated keys are recognizable by the device as dialing or addressing instructions for the communication apparatus.

The invention allows a user to remember how to contact a person by remembering a musical pattern associated with that person. The invention also allows a user to dial without needing to see the keys as auditory feedback is provided.

In another aspect of the invention, the musical patterns may be retained in memory and exchanged with other similar apparatus through communication means.

In a further aspect of the invention, the music keys are separate from other keys that provide full alphanumeric capability and the music keys are positioned for optimal access by a user's fingers when holding the apparatus.

In another aspect, an incoming communication is identified with a stored musical pattern and the stored musical pattern is sounded to announce the incoming communication.

In a further aspect, the invention enables users of two or more devices according to the invention to exchange musical patterns and to cooperate in authorizing a musical composition in a music jam during a communication or in the course of several communication sessions.

In one aspect, the invention comprises a communication apparatus including a first set of keys; and a second set of keys comprising a plurality of dedicated keys each capable of producing a musical tone when pressed. The first set of keys may be covered by means such as a flip cover, but the second set of keys is preferably not covered.

In a further aspect, the communication apparatus of the invention may comprise processing means and a musical note generator to convert input from the second set of keys to at least one musical note. In yet a further aspect, signal processing may be used to manipulate the at least one musical note. The manipulation may comprise converting at least one musical note to resemble a similar note played by a musical instrument. Feedback means may be included, to signal to a user that a particular sequence has been properly entered.

In a further aspect, the communication apparatus of the invention may comprise memory means to store a pattern of musical tones and to associate the pattern with a stored address. The address may be a telephone number, an email address and/or an instruction to a controller of an appliance.

In another aspect, the communication apparatus of the invention may comprise a receiver for receiving a signal from the stored address and signal means to replay the musical tone upon receipt of the signal.

In another aspect, the communication apparatus of the invention may further comprise means to download a musical pattern from a remote memory bank.

In another aspect, the invention comprises a method of communicating comprising the steps of a user using a communication apparatus comprising a first set of keys, a second set of keys comprising a plurality of dedicated keys each capable of producing a musical tone when pressed, to access a first musical pattern stored by another user; adding at least one musical note to the first musical pattern using the second set of keys, thereby producing a second musical pattern; and storing the second musical pattern in a memory of the communication apparatus.

In a further aspect, the invention may comprise the further steps of associating said second musical pattern with an address; and contacting the address upon input of the second musical pattern. The address may be a telephone number and/or an email address. The second musical pattern may also be used as a ringtone, with the communication apparatus playing the second musical pattern upon receipt of a signal from that address. Further, the second musical pattern may be communicated to at least one of another user or a remote server.

In yet another aspect, the invention comprises a communication apparatus comprising a plurality of dedicated keys each being capable of producing a musical tone when pressed; memory to store a sequence of musical tones and to associate the sequence with a stored address; contacting means to contact the stored address upon input of the musical tone; and a processor and a musical note generator to convert input from the key to at least one musical note. The invention may further comprise processing to manipulate the at least one musical note wherein the manipulation comprises converting the at least one musical note to resemble a similar note played by a musical instrument.

In another aspect, the musical tones produced by said keys may be selectively suppressed.

In yet another aspect, the invention comprises a method of communicating comprising the steps of producing a musical pattern on a communication apparatus comprising a first set of keys and a second set of keys comprising a plurality of dedicated keys each capable of producing a musical tone when pressed; associating the musical pattern with an address; and contacting the address upon input of the musical pattern. In a further aspect, the method of communication may comprise the further steps of receiving a signal from the address and playing the musical pattern upon receiving the signal. The method may also comprise the further step of sending the musical pattern to a remote memory bank. The method may comprise the further step of signaling to a user that the musical pattern has been inputted.

### BRIEF DESCRIPTION OF THE DRAWINGS

The invention will be described by reference to the detailed description of the preferred embodiment and to the drawings thereof in which:

FIG. 1 is a perspective view of a telephone handset according to the preferred embodiment;

FIG. 2 is a perspective view of a hand grasping a handset according to the preferred embodiment;

FIG. 3 is a perspective view of a telephone handset with its cover open, according to the preferred embodiment; and

FIG. 4 is a schematic view of a communication apparatus in a network.

### DETAILED DESCRIPTION OF THE PREFERRED EMBODIMENT

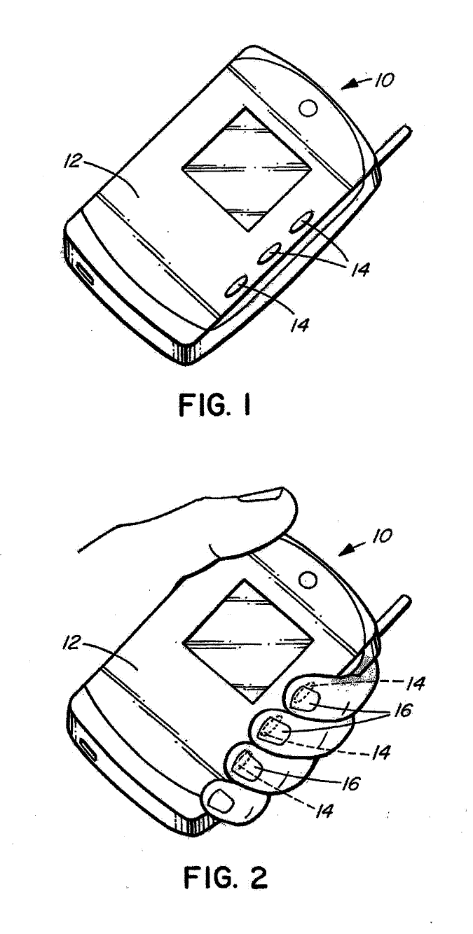

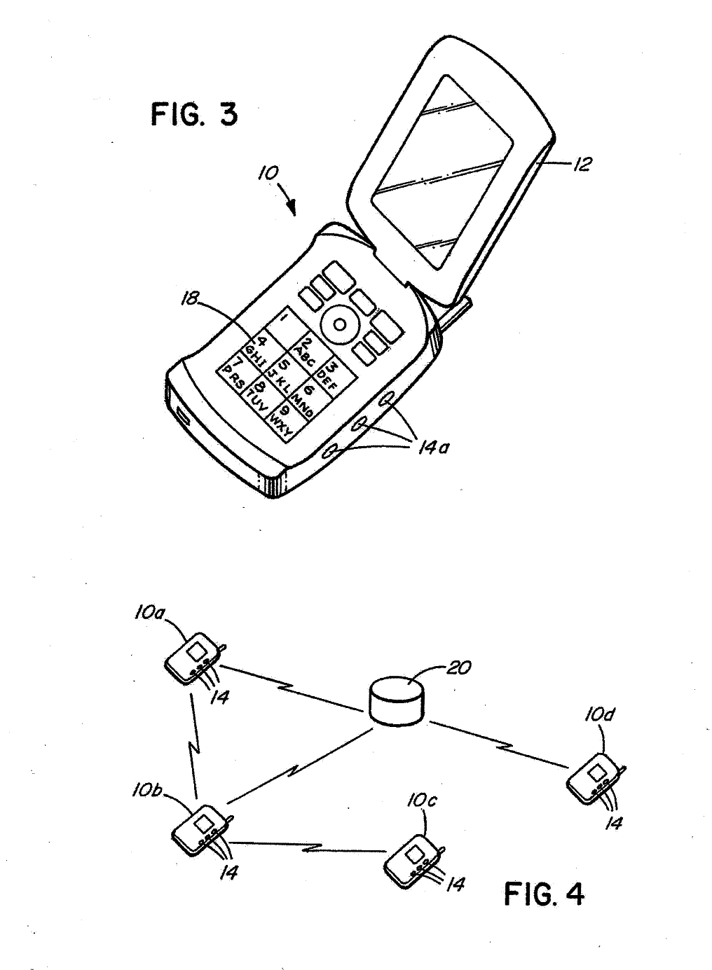

The preferred embodiment of the invention is a telephone handset 10 as illustrated in FIG. 1. A flip cover 12 is provided for selectively providing access to a first set of keys, for example, a full alphanumeric keypad 18 which is covered when the flip cover 12 is closed (as in FIG. 1), and accessible for use when the flip cover 12 is open (as in FIG. 3). In the closed position, the flip cover 12 nonetheless allows access toward the side of the handset 10 to a second set of keys comprising a plurality of dedicated keys each capable of producing a musical tone when pressed, namely three music keys 14 for implementing the invention, as shown in FIG. 1. The music keys 14 are positioned so as to be at the user's finger tips 16 when grasping the handset 10, as seen in FIG. 2.

In an alternate embodiment, the keys 14a may be placed on the side of the handset 10, as shown in FIG. 3. Keys 14a are then accessible whether flip cover 12 is in an open or closed position.

Each of the three music keys 14 is associated with a distinct musical note that is audibly played back when the key is pressed. Different musical notes are also generated when combinations of two (or all three) keys 14 are pressed simultaneously. Processing means and a musical note generator (not shown) are provided in the handset 10 for converting the selected keys 14 to the appropriate musical notes. The timing between key strokes can also be used as a characterizing feature of the pattern. Signal processing is used to further allow the user to render a given note as a particular musical instrument (e.g. a piano or a trumpet) and to otherwise manipulate the sound associated with a given key 14.

The audible playback of the musical sound associated with the keys 14 may be suppressed at the option of the user.

Memory means are provided for associating patterns of musical notes (as generated by sequential selection of the keys 14) with stored addresses of other users, such as telephone numbers or email addresses. In the case of a stored telephone number, when a given inputted pattern is detected, the appropriate stored telephone number is dialed. In order to signal to the user that the entire musical pattern has been properly inputted and has been recognized as a memorized pattern, feedback means may be employed. Such feedback may comprise playing back the musical pattern its entirety or activating a vibrator, for example.

The invention allows the user to associate given individuals (through their telephone number) with particular musical riffs or patterns composed using the music keys 14 and to dial such individuals by reproducing the appropriate riff or pattern, rather than by recollecting an alphanumeric sequence representative of a telephone number. The invention also allows one to use a small number of keys 14, within easy reach of the fingers 16 when holding the handset 10 as seen in FIG. 2, in order to dial.

The musical riff or pattern associated with a given individual may also be used as the ringtone for incoming calls or messages originating from that individual. In this case, the communication apparatus includes a receiver for receiving a signal from that individual, and signal means to replay the associated musical riff or pattern. Different users of the devices according to the invention may send to one another their “signature” musical pattern so that the recipient may configure the musical pattern in question as the ringtone for the sender.

In a further embodiment, rather than generating a specific musical note, one or more of the music keys 14 may be configured to generate a musical sequence consisting of more than a single note such that pressing several keys 14 or key combinations in sequence may generate a more complex musical composition. Musical patterns or segments of music may be downloaded to the phone and recorded in the phone memory, allowing the user to optionally designate such longer music patterns to play back when a given key 14 or pattern of keys 14 is pressed.

The musical sequence generated by successive keys or combinations of keys may be stored in the device such that the user can call up and forward a designated sequence by electronic messaging or email to a remote user equipped with a similar device. Processing functions allow the recipient of such sequence to concatenate it with previously stored sequences. In this manner, users can cooperate to build a musical composition in stages. This can be facilitated by storing the output of each successive session at a designated server 20 or in the device 10a, 10b, 10c of one of the participants, as best shown in FIG. 4. The resulting compositions can themselves be associated with a given music key 14 of a device 10 to allow for the use of more complex compositions in dialing.

The music keys 14 in combination with the basic communication capability of the device allow a plurality of users 10a, 10b, 10c to interact in a real time jam session by playing their respective music keys 14 while in communication with one another.

A server 20 may be maintained to serve a network of any number of devices, such as 10a, 10b, 10c, 10d etc. equipped with music keys 14 according to the invention. The server 20 includes a database associating individual musical signatures and telephone numbers, thereby enabling other users, such as 10d, to download the information. The central server 20 may also include particular key configurations and associated musical notes or patterns for downloading by various users 10a-10d etc.

While the preferred embodiment has been described and illustrated using three music keys 14, it is contemplated that the invention will be applicable with up to five keys corresponding to the five digits of a user's hand. However, it is contemplated that even a single key may be programmed to output different musical notes and different treatment of such notes according to how long the key is held down and according to the interval between keystrokes.

Depending on how many music keys are used, they may also be configured to additionally provide operational functionality to the phone for functions such as answer call, select displayed item, scroll, send or hang up. Table 1 illustrates exemplary musical output and functions for a device having three music keys according to the invention.

TABLE 1

| Key(s) pressed | Output/function |
|---|---|
| 1 | do-mi; answer call |
| 1 + 2 | fa-sol; scroll menu |
| 2 | re; select menu item |
| 2 + 3 | la; send |
| 3 | si; hang up |

While the preferred embodiment has been described in relation to a telephone handset, the principles of the invention can be applied to provide keypad input on other articles equipped for communication functions. For example, an email address is composed of alphanumeric characters but a keyboard for a computer processor could be equipped with selected music keys to implement the invention for addressing email. The invention will find particular applicability in cases where the user's hands are constrained in their ability to maneuver and/or where there are constraints on the user's visual field or attention. For example, keypad input according to the invention may be arranged on the steering wheel of a vehicle such that music keys are located at the user's finger tips. In such embodiment, the input device would be connected to communication apparatus.

In another embodiment, rather than providing a communication function, the music key input device can be used to provide control functions to apparatus such as household appliances. For example, the element of a stove may be set to simmer using a particular musical pattern or to high or boil using another musical pattern.

Although the preferred embodiment and alternative embodiments have been described herein, it will be appreciated that the scope of the invention is not intended to be restricted thereby, such scope instead being discerned from a combination of such disclosure and the claims that follow.

What is claimed is:

1. A communication apparatus comprising:
a first set of keys;
a second set of keys separate from and non-overlapping with said first set of keys, comprising a plurality of dedicated keys each capable of producing a musical tone when pressed.

2. The communication apparatus of claim 1 further comprising processing means and a musical note generator to convert input from said second set of keys to at least one musical note, and signal processing to manipulate said at least one musical note.

3. The communication apparatus of claim 2 wherein said manipulation comprises converting said at least one musical note to resemble a similar note played by a musical instrument.

4. The communication apparatus of claim 1 further comprising memory means to store a pattern of said musical tones and to associate said pattern with a stored address.

5. The communication apparatus of claim 4 wherein said address is selected from the group comprising a telephone number, an email address, and an instruction to a controller of an appliance.

6. The communication apparatus of claim 1 or 4 wherein said second set of keys comprises 5 or fewer keys.

7. The communication apparatus of claim 1 or 4 wherein said second set of keys are positioned on a side of said apparatus.

8. The communication apparatus of claim 4 further comprising a receiver for receiving a signal from said address and signal means to replay said musical tone upon receipt of said signal.

9. The communication system of claim 4 further comprising feedback means to indicate to a user that said musical tone has been inputted.

10. The communication system of claim 4 further comprising means to download a musical pattern from a remote memory bank.

11. A method of communicating comprising the steps of:
a user using a communication apparatus comprising a first set of keys, a second set of keys comprising a plurality of dedicated keys each capable of producing a musical tone when pressed, to access a first musical pattern stored by another user;
adding at least one musical note to said first musical pattern using said second set of keys, thereby producing a second musical pattern; and,
storing said second musical pattern in a memory of said communication apparatus.

12. The method of claim 11 further comprising the steps of:
associating said second musical pattern with an address; and,
contacting said address upon input of said second musical pattern.

13. The method of claim 11 further comprising the steps of communicating said second musical pattern to at least one of another user or a remote server.

14. The method of claim 12 wherein said address is selected from the croup comprising a telephone number and an email address.

15. The method of claim 12 comprising the further steps of receiving a signal from said address and playing said second musical pattern upon receiving said signal.

16. A communication apparatus comprising:
a plurality of dedicated keys each being capable of producing a musical tone when pressed;
memory to store a sequence of said musical tones and to associate said sequence with a stored address;
contacting means to contact said stored address upon input of said musical tone; and,
a processor and a musical note generator to convert input from said key to at least one musical note.

17. The communication apparatus of claim 16 further comprising signal processing to manipulate said at least one musical note wherein said manipulation comprises converting said at least one musical note to resemble a similar note played by a musical instrument.

18. The communication apparatus of claim 16 wherein said address comprises a telephone number or an email address.

19. The apparatus of claim 16 wherein said address comprises an instruction to a controller of an appliance.

20. The communication apparatus of claim 16 wherein said first set of keys comprises 5 or fewer keys.

21. The communication apparatus of claim 20 wherein said first set of keys are positioned on a side of said apparatus.

22. A method of communicating comprising the steps of:
producing a musical pattern on a communication apparatus comprising a first set of keys and a second set of keys comprising a plurality of dedicated keys each capable of producing a musical tone when pressed;
associating said musical pattern with an address; and,
contacting said address upon input of said musical pattern.

23. The method of claim 22 comprising the further steps of receiving a signal from said address and playing said musical pattern upon receiving said signal.

24. The method of claim 22 comprising the further step of sending said musical pattern to a remote memory bank.

25. The method of claim 22 comprising the further step of signaling to a user that said musical pattern has been inputted.
